(19) United States
(12) Patent Application Publication
(10) Pub. No.: US 2005/0214622 A1
(43) Pub. Date: Sep. 29, 2005

(54) Fuel cell

(75) Inventors: Shoji Yoshioka, Tokyo (JP); Tatsunori Okada, Tokyo (JP); Osamu Hiroi, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/893,874

(22) Filed: Jul. 20, 2004

(30) Foreign Application Priority Data
Mar. 23, 2004 (JP) 2004-085133

(51) Int. Cl. H01M 8/02; H01M 4/94

(52) U.S. Cl. 429/38; 429/39; 429/44

(57) ABSTRACT

A fuel cell in which gas short-cutting is prevented without reducing effective area for electrode reaction. At least one of a fuel gas flow path and an oxidizing gas flow path includes flow grooves having bends and fluid flowing between ends of the flow grooves. The effective reaction area of the flow grooves on a separator plate is rectangular, having a first side in the direction along which the bends are aligned longer than a second side in the direction along their main extents, located upstream and downstream of the bends, where the fluid flows in opposing directions.

### BACKGROUND OF THE INVENTION

1. Field of the Invention

The present invention relates to fuel cells using an electrochemical reaction, and in particular, to the prevention of short-cutting of gas flowing in flow paths.

2. Description of the Related Art

In general, fuel cells comprise: an electrochemical electricity-generating element that sandwiches and holds an ion-conducting electrolyte membrane, via catalytic layers, between a fuel electrode and an oxidizing electrode that include the catalytic layers and gas-diffusion layers that are porous bodies; and separator plates, disposed on either side of the electrochemical electricity-generating element, on which are arranged a fuel fluid flow path (fuel gas flow path) and an oxidizing fluid flow path (oxidizing gas flow path) for supplying fuel fluid (fuel gas) and oxidizing fluid (oxidizing gas), respectively, for the fuel electrode and the oxidizing electrode.

In this type of fuel cell, the gas diffusion layers smoothly transfer reaction gases (the fuel gas and the oxidizing gas) from the gas flow paths to the catalytic layers, and while having a function to discharge reaction-generated products, such as generated gas and water, to the gas flow paths, at the same time form short-cutting paths for the reaction gases, when the cell is viewed on the flat, causing a decrease in gas usage efficiency.

Conventional fuel cells, for example as disclosed in Japanese Laid-Open Patent Publication 2001-76746 (page 3, FIG. 1), comprise single cells in which the electrolyte membrane is sandwiched and held by the fuel electrode and the oxidizing electrode, and the separator plates on which a parallel fuel flow-groove group, formed of a plurality of parallel grooves, supplies the fuel gas to the fuel electrode, and on which a parallel oxidizing flow-groove group, formed of a plurality of parallel grooves, supplies the oxidizing gas to the oxidizing electrode, with both flow-path groups running in bends, and the cells and separator plates being sequentially built up to form a laminated body. In this type of fuel cell, ridge widths between adjacent parallel flow-groove groups are made larger than the ridge widths between the grooves within the parallel flow-groove groups, so that gas short-cutting within the separator flow paths is reduced.

In regulating the inter-groove distances (the ridge widths) in the above described conventional fuel cells, when the ridge widths are made extremely wide for the purpose of avoiding gas short-cutting as much as possible, there has been a problem in that it becomes difficult to diffuse the reaction gas to the catalytic layers in these regions, and the reaction face of the electrodes does not function effectively.

### SUMMARY OF THE INVENTION

The present invention is directed at solving the problems of the conventional fuel cells as described above, and has as an object the provision of a fuel cell that can prevent gas short-cutting without reducing effective area for electrode reaction.

The fuel cell related to the present invention is provided with an electrochemical electricity-generating element that sandwiches and holds an ion-conducting electrolyte membrane, via catalytic layers, between each of a fuel electrode that includes a catalytic layer and a gas-diffusion layer that are porous bodies and an oxidizing electrode that includes a catalytic layer and a gas-diffusion layer that are porous bodies; a separator plate, disposed on one side of the electrochemical electricity-generating element, on which is arranged a fuel gas flow path for supplying fuel gas to the fuel electrode; and a separator plate, disposed on the other side of the electrochemical electricity-generating element, on which is arranged an oxidizing gas flow path for supplying oxidizing gas for the oxidizing electrode. At least one of either the fuel gas flow path or the oxidizing gas flow path is configured with flow grooves running in bends, and fluid flowing from one end to the other end of the flow grooves. The form of the effective reaction area of the flow grooves grooved on the separator plates is rectangular, with the length (H) of the flow grooves in a first direction along which the bends are aligned being longer than the length (L) of the flow grooves in a second direction along their main runs located upstream and downstream of the bends, where fluid flows in opposing directions.

### BRIEF DESCRIPTION OF THE DRAWINGS

A preferred embodiment of the present invention will be described in detail with reference to the figures, wherein:

FIG. 1 is a sectional explanatory view of a fuel cell according to Embodiment 1 of the present invention and illustrates the simulated appearance of the main members of the fuel cell cut through the layer-stack;

FIG. 2 is a plan view of an anode side separator plate seen from an anode gas diffusion layer side, to explain the fuel cell according to Embodiment 1 of the present invention;

FIG. 3 is a characteristic chart diagramming the relationship between H/L and short-cutting proportion and also cell voltage, to explain the fuel cell according to Embodiment 1 of the present invention; and

FIG. 4 is a characteristic chart diagramming the relationship between H/L and the short-cutting proportion and also the cell voltage, to explain the fuel cell according to Embodiment 2 of the present invention.

### DETAILED DESCRIPTION OF THE PREFERRED EMBODIMENTS

### Embodiment 1

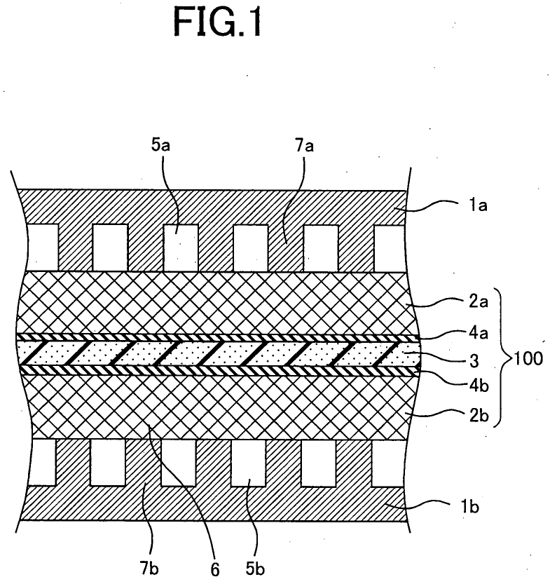

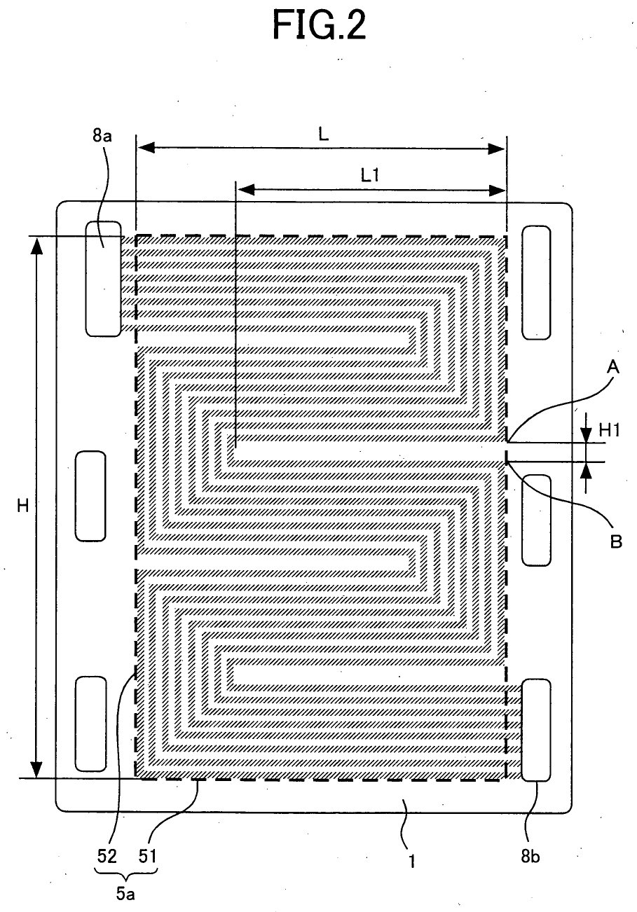

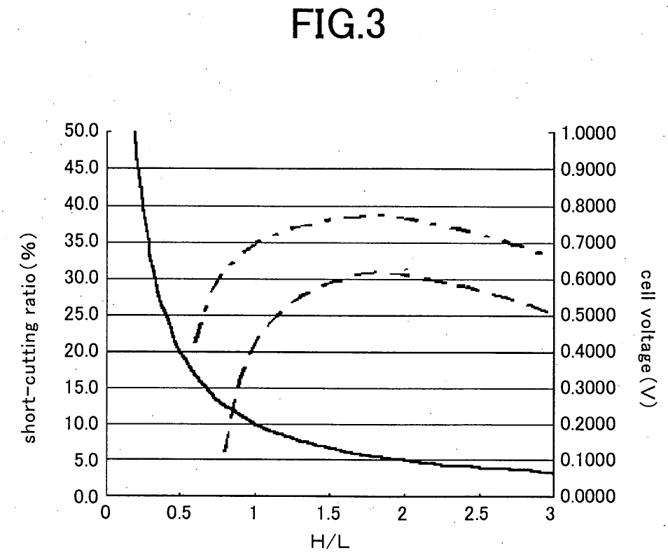

FIG. 1˜FIG. 3 are explanatory views of a fuel cell according to Embodiment 1 of the present invention, and more specifically, FIG. 1 is a sectional view illustrating the simulated appearance of main members of the fuel cell cut through the layer-stack; FIG. 2 is a plan view of a side separator plate on an anode side, seen from a gas diffusion layer side on the anode side, FIG. 3 is a characteristic view illustrating a relationship between H/L and short-cutting proportion and also cell voltage.

As illustrated in FIG. 1, the present embodiment is configured as a 7-layered laminated structure unit built up of, in order, the anode side (fuel electrode side) separator plate 1a, the anode gas diffusion layer 2a, an anode catalytic layer 4a, a proton-exchange electrolyte membrane 3, a cathode (oxidizing electrode) catalytic layer 4b, a cathode gas diffusion layer 2b and a cathode side separator plate 1b. That is, the embodiment is provided with: an electrochemical electricity-generating element 100 that sandwiches and holds the ion-conducting electrolyte membrane 3, via the catalytic layers 4a and 4b, between a fuel electrode that includes the anode gas diffusion layer 2a and the anode catalytic layer 4a, formed of porous bodies, and an oxidizing electrode that includes the cathode gas diffusion layer 2b and the cathode catalytic layer 4b, formed of porous bodies; and the separator plates 1a and 1b disposed on either side of the electrochemical electricity-generating element 100, on which are arranged a fuel gas flow path and an oxidizing gas flow path for supplying fuel gas and oxidizing gas, respectively, for the fuel electrode and the oxidizing electrode.

Furthermore, flow grooves 5a that form an anode gas flow path are formed on the face on the anode electrode (the anode gas diffusion layer 2a) side of the anode-side separator plate 1a, and on the face on the opposite side a flow path, which is not illustrated, for coolant water is formed. Similarly, flow grooves 5b that form a cathode gas flow path are formed on the face on the cathode electrode (the cathode gas diffusion layer 2b) side of the cathode-side separator plate 1b, and on the face on the opposite side a flow path, which is not illustrated, for coolant water is formed. Ridges 7a are disposed between adjacent flow grooves 5a on the anode side separator plate 1a, and ridges 7b are disposed between adjacent flow grooves 5b on the cathode side separator plate 1b.

One electricity generating unit, in which the anode side separator plate 1a and the cathode side separator plate 1b are disposed on either side of the electrochemical electricity-generating element 100, is illustrated in FIG. 1; however, in practice, fuel cells are often configured of a plurality of layers of this type of electricity-generating unit. Additionally, the anode side separator plate 1a and the cathode side separator plate 1b are not restricted to being separate members, and a fuel cell laminated body may be configured using a consolidated type of separator plate where the fuel gas flow paths 5a are arranged on one main face and the oxidizing gas flow paths 5b are arranged on the other main face, and the fuel cell laminated body may be built up of alternate layers of this separator plate and the electrochemical electricity-generating element 100.

As illustrated in FIG. 2, in the fuel cell in accordance with this embodiment at least one of either the fuel gas flow path or the oxidizing gas flow path (although FIG. 2 only shows the fuel gas flow path, both are present in this embodiment) runs in eight of the flow grooves 5a (illustrated by means of hatching in FIG. 2) that run in bends. Furthermore, at either end of each of the flow grooves 5a, a gas supply manifold 8a (fuel gas inlet manifold) and a gas discharge manifold 8b (fuel gas outlet manifold), to which the eight flow grooves 5a collectively communicate, are provided, and the configuration is such that gas flows from one end of the flow grooves 5a to the other end.

The form of the effective reaction area (the area surrounded by a broken line in FIG. 2) of the flow grooves 5a grooved on the separator plate 1a, is rectangular, with a length H of the flow grooves 5a in a first direction along which the bends 52 are aligned being longer than a length L in a second direction along the main runs 51 located upstream and downstream of the bends 52, where fluid flows in opposing directions.

With a proton-exchange membrane fuel cell, since the operating temperature is low—about 80° C.—almost all water generated by the electrochemical reaction does not vaporize but flows as a liquid through the oxidizing flow grooves 5b. Since it is difficult for a liquid, as compared to a vapor, to move from a low position to a higher one, the direction of the main runs 51 of the oxidizing gas flow grooves 5b is set to be mainly horizontal, and the direction in which the bends 52 are aligned is set to be mainly vertical, and in general usage, fluid including the oxidizing gas is made to flow from a higher position to a lower one in the oxidizing gas flow grooves 5b. The following explanations are given assuming this type of setup. In these cases, the direction in which the bends 52 of the flow grooves 5a are aligned is longitudinal, and the direction of the main runs 51 of the flow grooves is lateral.

In FIG. 2, the flow volume of gas that short-cuts between adjacent points A and B within the flow groove portions is proportional to the pressure difference between the point A and the point B. The pressure difference is proportional to the length of the flow grooves from the point A as far as the point B—the sum of H1 and twice L1, (H1+2×L1). Therefore, by changing the longitudinal-lateral proportion of the effective reaction area in the separators, that is, by enlarging H/L, the pressure difference between the point A and the point B can be made small, and as a result, it is possible to prevent gas short-cutting within the gas diffusion layers, without decreasing the effective reaction area of the electrodes.

FIG. 2 is a simulated view of the separator on which a parallel flow groove group, with flow groove widths of 2 mm and flow groove intervals of 2 mm, is formed between an inlet manifold 8a and an outlet manifold 8b. The number of grooves in the parallel flow groove group is eight, and they bend back five times along the flow path. Furthermore, in the separator illustrated in FIG. 2, L=12.5 cm, H=16 cm, and the effective reaction area surrounded by the broken line is 12.5×16=200 cm².

For an effective reaction area of 200 cm² and eight flow grooves, FIG. 3 illustrates the relationship of the H/L fraction—the longitudinal length H versus the lateral length L —with the computed value of the gas short-cutting ratio and the cell voltage. However, the flow groove widths and the flow groove intervals are both fixed at 2 mm, and the number of bends is adjusted accordingly. In FIG. 3, the continuous line is the short-cutting ratio, the broken line is the cell voltage for a fuel usage rate of 95%, and the dot-and-dash line is the cell voltage for a fuel usage rate of 85%.

As mentioned above, the gas short-cutting volumes are proportional to the pressure differences at each point, and the calculated result of the pressure difference between the adjacent flow grooves, the movement resistance and thickness of the gas diffusion layers between the flow grooves, and the distances between the flow grooves are illustrated as parameters.

Measurement of battery (cell) voltage is carried out using an electricity-generating unit made as follows. The electrochemical electricity-generating element 100 is formed by pressure-bonding the fuel electrode and the oxidizing electrode on either side of the electrolyte membrane 3. A perfluorocarbon sulfonic acid proton exchange membrane of 50 μm thickness is used as the electrolyte membrane 3. Platinum or platinum ruthenium alloy powder, supported with carbon, kneaded together with electrolyte membrane ingredients into paste (the catalytic layers 4a and 4b), coated on 0.3 mm thick carbon paper—the gas diffusion layers 5a and 5b—is used as the fuel electrode and the oxidizing electrode. The electricity generating unit is configured by forming the separator plates 1a and 1b cut from a carbon plate of 2 mm thickness, and by sandwiching and pressuring to a surface pressure of 5 kgf/cm² the electrochemical electricity generating element 100 between the separator plates 1a and 1b of, respectively, the anode and cathode.

Operating conditions are described as follows. In order to generate electricity using a fuel usage rate at as high an efficiency as possible, a high usage rate of 85% or 95% is set, and oxygen usage rate is made 40%. In the fuel gas, hydrogen and carbon dioxide are mixed at a ratio of 3:1, and reformed dummy gas, to which carbon monoxide is added at 10 ppm, is used. Air is used as the oxidizing gas. Before sending the fuel gas and the oxidizing gas to the electricity-generation unit, humidification is done by bubbling through water at 70° C. Measurement of the cell voltage is carried out at a current density of 250 mA/cm and a battery temperature of 75° C. The cell temperature is set at a fixed temperature by disposing water cooling plates on either end of the electricity-generation unit, and by making 75° C. hot water flow through at 300 cc/min.

In the gas short-cutting ratio shown by a solid line in FIG. 3, H/L changes gradually and smoothly from around 0.5, and it is known that from the general region when H/L exceeds 1, it becomes even smoother. Furthermore, from the general region where H/L exceeds 1, the short-cutting ratio becomes less than 10% and has a practicably applicable value.

The cell voltages, illustrated by the broken line and the dot-and-dash line, both peak where H/L is in the region of 1.8.

With a fuel usage rate of 95%, from the region where H/L exceeds 1, it becomes possible to stably sustain the cell voltage. In addition, with a fuel usage rate of 85%, when H/L is greater than 1 and less than 2.5, the cell voltage has a practicable value of 0.7 V or greater.

From these facts it is preferable that H/L be greater than 1 and less than 2.5.

Furthermore, it is even more preferable that H/L be greater than 1.2, since the increased cell voltage is more stable.

Moreover, H/L should preferably be less than 2, and even more preferably be less than 1.8.

The cell voltage decrease when H/L exceeds a certain value (in the region of 1.8), as in FIG. 3, is thought to be related to drying of the flow path inlet or flooding phenomena at the outlet. In general, since the water produced in the fuel cell is discharged after flowing along the flow path, the water tends to accumulate in the flow path in the neighborhood of the outlet (the neighborhood of the outlet manifold 8b), and as a result the electrode (catalytic layer) is inundated with water, and the flooding phenomenon occurs wherein the reaction gas cannot easily reach the electrode. When H/L becomes large, the distance (H) in the gravitational direction from the. upper portions of the flow path to the lower portions becomes long, and thus it seems that it becomes difficult to pass the water localized in the lower portions of the flow path through the electrolyte membrane and the gas diffusion layer, and to circulate it to the relatively dry gas inlet region where the membrane resistance of the electrolyte is large.

FIG. 3 illustrates cases where the fuel usage rate is high; cases where the oxidizing usage rate is high are similar.

### Embodiment 2

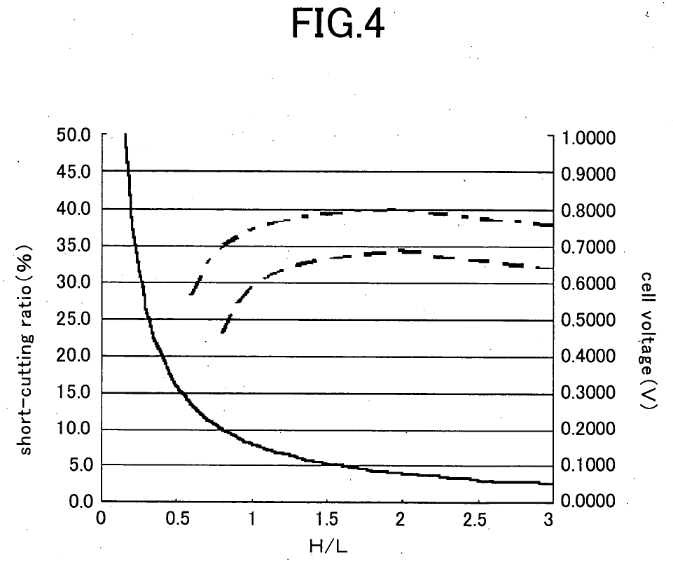

FIG. 4 is an explanatory view of the fuel cell according to Embodiment 2 of the present invention, and more specifically, it is a characteristic view illustrating the short-cutting ratio and the cell voltage versus H/L relationship.

Embodiment 1 has eight flow grooves that run in bends; this embodiment, however, has sixteen flow grooves that run in bends. The width of the gas flow grooves and the interval between the flow grooves are each 1 mm. Other details of the configuration are similar to those of Embodiment 1.

For an effective reaction area of 200 cm² and sixteen flow grooves, FIG. 4 illustrates the relationship of the H/L fraction—the longitudinal length H versus the lateral length L—to the computed value of the gas short-cutting ratio and the cell voltage. However, the flow groove widths and the flow groove intervals are both fixed at 1 mm, and the number of bends is adjusted accordingly. In FIG. 4, the continuous line is the short-cutting ratio, the broken line is the cell voltage for a fuel usage rate of 95%, and the dot-and-dash line is the cell voltage for a fuel usage rate of 85%.

In the present embodiment, the relationships of the short-cutting ratio and the cell voltage versus H/L exhibit similar tendencies to those of Embodiment 1 with the eight flow grooves. In FIG. 4 also, it is known that H/L should preferably be greater than 1 and less than 2.5, and even more preferably should be greater than 1.2.

The above embodiments have illustrated cases with eight or sixteen flow grooves 5a that run in bends, and these flow grooves 5a together communicate with the fluid supply manifold 8a and the fluid discharge manifold 8b; however, the number of flow grooves 5a is not limited to eight or to sixteen, and a plurality of flow grooves or one single flow groove may also be used.

The above embodiments have illustrated cases where both the fuel gas flow path and the oxidizing gas flow path are configured with flow grooves running in bends so that the fluid flows from one end to the other in the flow grooves, and the form of the effective reaction area of the flow grooves grooved on the separator plates is rectangular, with the length H of the flow grooves in the direction in which the bends are aligned, longer than the length L in the direction of the main runs located upstream and downstream of the bends, where fluid flows in opposing directions; however, it is also feasible where at least one of either the fuel gas flow path or the oxidizing gas flow path is configured in this way.

As explained in the above embodiments, in addition to making the form of the effective reaction area of the flow grooves grooved on the separator plates rectangular, with the length H of the flow grooves in the direction in which the bends are aligned being longer than the length L in the direction of the main runs located upstream and downstream of the bends, the width of the ridges between adjacent upstream flow groove portions and downstream flow groove portions may be made wider than the width of other ridges. By additionally regulating the ridge widths in this way, it is possible to prevent the gas short-cutting with greater assurance.

In each of the above embodiments of the present invention, explanations have been given for cases applied to proton-exchange membrane fuel cells; however, the explanations may also be applied to phosphoric acid fuel cells.

The operating temperature of phosphoric acid fuel cells is in the region of 150° C.˜200° C., and water produced by the electrochemical reaction vaporizes into a gas. Therefore, the direction of the main runs 51 of the oxidizing gas flow grooves 5b need not necessarily be mainly horizontal and the direction in which the bends 52 are aligned need not necessarily be mainly vertical, as in the proton-exchange membrane fuel cells; for example, the direction in which the bends 52 are aligned may be arranged to be in a mainly horizontal direction.

According to the present invention, it is possible to make small the pressure difference between the adjacent flow groove portions without changing the effective reaction area, and the gas short-cutting can be prevented without reducing the effective area for the electrode reaction.

Further, the invention is not limited to the embodiments described above, and changes may be freely made within the spirit and scope of the invention.

1. A fuel cell comprising:
an electrochemical electricity-generating element including an ion-conducting electrolyte membrane, sandwiched via porous catalytic layers, between a fuel electrode that includes a porous gas-diffusion layer and one of said catalytic layers, and an oxidizing electrode that includes a porous gas-diffusion layer and another of said catalytic layers;
a first separator plate, disposed on a first side of the electrochemical electricity-generating element, including a fuel fluid flow path for supplying fuel fluid for the fuel electrode; and
a second separator plate, disposed on a second side of the electrochemical electricity-generating element, including an oxidizing fluid flow path for supplying oxidizing fluid for the oxidizing electrode, wherein
at least one of the fuel gas flow path and the oxidizing gas flow path includes flow grooves having bends, fluid flowing between ends of said flow grooves, and
an effective reaction area of the flow grooves where the first and second separator plates are grooved is rectangular, with a first side in a first direction along which the bends are aligned that is longer than a second side in a second direction along main portions of the grooves, located upstream and downstream of the bends, where fluid flows in opposing directions.

2. The fuel cell as set forth in claim 1, wherein ratio of the first side in the first direction to the second side in the second direction is greater than 1 and less than 2.5.

3. The fuel cell as set forth in claim 2, wherein the ratio of the first side in the first direction to the second side in the second direction is greater than 1.2.

4. The fuel cell as set forth in claim 2, wherein the ratio of the first side in the first direction to the second side in the second direction is less than 2.

5. The fuel cell as set forth in claim 2, wherein the ratio of the first side in the first direction to the second side in the second direction is less than 1.8.
